(19) United States
(12) Patent Application Publication
(10) Pub. No.: US 2017/0007072 A1
(43) Pub. Date: Jan. 12, 2017

(54) Kebob tongs

(71) Applicant: Robert M. Stern, Toms River, NJ (US)

(72) Inventor: Robert M. Stern, Toms River, NJ (US)

(21) Appl. No.: 14/545,938

(22) Filed: Jul. 10, 2015

(51) Int. Cl. A47J 37/04

(52) U.S. Cl. CPC A47J 37/049; A47J 37/04

(57) ABSTRACT

Tongs for manipulating shish-kebob on a barbeque grill, the tongs having two arms, the two arms being in parallel relationship at an insulated handle end, which includes a pivot point, the arms diverging at the opposing end of the handle end, to form two opposing, spaced apart arms having kebob engaging ends, each end having a horizontal slot formed in the tip of the kebob engaging ends, the slit having a notched closed end, the slot and notch for the receipt of the ends of a skewer, the tongs being compressed so that the kebob engaging ends engage the outer food items on the skewer preventing their rotation so that the kebob can be flipped for even cooking on the opposing side and for removal from the grill.

### RELATED APPLICATIONS

Applicant claims the benefit of provisional application Ser. No. 62/124,643, filed Dec. 29, 2014.

### BACKGROUND OF THE INVENTION

1. Field of the Invention

The present invention relates to barbeque tongs which are utilized to manipulate food items being grilled on an outdoor or indoor grill using wood, charcoal, or natural gas. In particular, the present invention relates to specifically designed tongs which are utilized to manipulate shish-kebobs so as to flip the shish-kebob from one side to the other to insure uniform cooking and to safely place and remove the shish-kebob from the grill without the threat of burning ones fingers.

2. Description of the Prior Art

Shish-kebobs are a popular food item to be cooked on a grill, particularly outdoors, in fair weather. The shish-kebob has its origins in the Middle East and Asia. It consists of a skewer onto which bite size pieces of meat, poultry, vegetables in the form of onions, peppers and the like, and carbohydrates, such as potatoes, are positioned. The skewers with the bite sized pieces of food in place, are then placed on a grill and heated. Preferably, the shish-kebob is cooked on one side and then flipped or rotated 180 degrees about the longitudinal skewer to insure even cooking of the food pieces on the opposing side before removal from the grill.

The skewers utilized for shish-kebob may vary. Typically, they are wooden sticks with points at the end which are soaked in water for a period of time before being utilized in an effort to prevent the wooden stick from searing or catching fire on the grill. Recent developments in the shish-kebob art include metal rods circular in cross section and having a circular ring handle at one end for ease of manipulation. To add flavor to the food, lemon grass stalks, sugar cane, and rosemary sprigs are sometimes used as the skewer. There are also metal skewers which are longitudinally planar having at least one pointed end.

The one problem that arises with shish-kebobs is that in the cooking process, the food items which in most situations are irregular in shape, when secured to the skewer, will oftentimes rotate about the skewer to seek their lower center of gravity when one tries to manipulate the kebob to turn the kebob from one side to the other. This prevents the food items from being cooked uniformly on both sides. Efforts have been made to address this problem. One effort is to make the cross section of the skewer square or rectangular in shape to lessen the possibility of rotation of the food items. Another solution is to use two skewers to prevent such rotation of the food items. Another is to use a two pronged skewer having a single handle. These solutions have had some success, but the problem persists and further problems exist with respect to the individual flipping the shish-kebob and removing the shish-kebob from the grill. Regardless of the type of skewer used, it becomes hot during the cooking process and sometimes difficult to grasp and remove from the grill without singeing one's fingers or hot pad.

Therefore, there has been a need for a mechanism which would allow an individual to safely flip or rotate a shish-kebob on the grill to insure even cooking on both sides and a method and apparatus for removing the shish-kebob from the grill once cooking is complete without the possibility of singeing or burning one's fingers on the skewer which has become heated as a result of the cooking process.

Applicant is the named inventor in U.S. Pat. No. 9,010,821 “KEBOB TONGS” issued Apr. 21, 2015. This application represents an improvement over the tongs of the '821 patent in the form of a new embodiment.

### OBJECTS OF THE INVENTION

An object of the present invention is to provide for a novel designed tong for cooking and moving shish-kebobs on a barbeque grill, which allows the shish-kebob to be flipped accurately for even cooking on both sides.

A further object of the present invention is to provide for novel shish-kebob tongs for use with shish-kebob on the grill which allows the chef to move the shish-kebob about the grill and to remove the shish-kebob from the grill without a danger of singeing or burning fingers or a hot pad.

Another object of the present invention is to provide for novel shish-kebob tongs for use with shish-kebob on a grill, the shish-kebob tongs allowing the secure gripping of the skewer of the shish-kebob when turning or flipping the shish-kebob on the grill or when removing the shish-kebob from the grill and transporting it.

### SUMMARY OF THE INVENTION

Tongs for manipulating shish-kebob on a barbeque grill, the tongs having two arms, the two arms being in parallel relationship at an insulated handle end which includes the pivot point at one end, the arms diverging at the opposing end of the handle end, to form two opposing spaced apart arms having kebob engaging ends, each engaging end having a horizontally oriented slot at the tip of the engaging end, the slots slidably engaging the ends of the skewer, the tongs handle end then being compressed so that the kebob engaging ends engage the outer food items on the skewer preventing their rotation so that the kebob may be either flipped for even cooking on the opposing side, or removed from the grill for consumption without endangering the fingers of the user. The slots also having opposing notches formed proximate the closed end and defining a circular receptacle to further engage the ends of a skewer of circular cross section.

### BRIEF DESCRIPTION OF THE DRAWINGS

These and other objects of the present invention will become apparent, particularly when taken in light of the following illustrations wherein:

FIG. 1 is a side view of a typical shish-kebob resting on a grill surface;

FIG. 2 is a top view of the shish-kebob tong of the present invention;

FIG. 3 is a perspective view of a shish-kebob tong of the present invention in an open configuration;

FIG. 4 is a top view of a shish-kebob tong of the present invention in a closed skewer engaging configuration;

FIG. 5 is a perspective view of the shish-kebob tong of the present invention; and

FIG. 6 is a side view of the shish-kebob tong of the present invention.

### DETAILED DESCRIPTION OF THE INVENTION

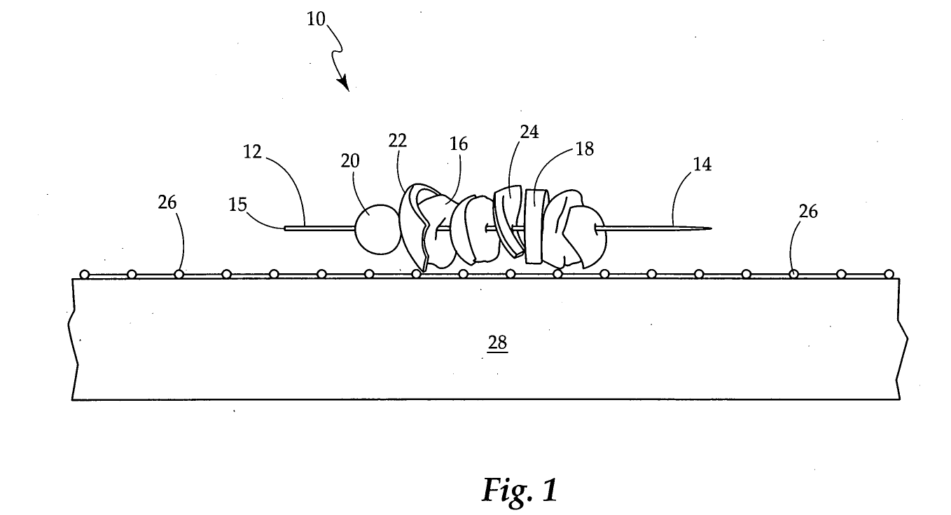

FIG. 1 is a side view of a typical shish-kebob resting on a grill surface. The shish-kebob 10 comprises a skewer 12 illustrated as a wooden stick having a pointed or tapered end 14 and opposing end 15. Onto the shish-kebob there is punctured food items. In the shish-kebob illustrated in FIG. 1, the food items from left to right are meant to represent a portion of meat 16, onion 18, tomato 20, potato 22, meat 16, pepper 24, potato 22, tomato 20, onion 18, and meat 16. The skewer 12 as illustrated in FIG. 1 is made of wood and would have been soaked for a period of time before being placed on the grill. However, skewers may also be fabricated from metal, bamboo, or other suitable material. The grill or grate 26 rests above a source of heat 28, which may be propane, charcoal, or wood.

It is desirable to cook the shish-kebob 10 evenly on all sides. Therefore as shown in FIG. 1, once the food in proximity to the grate 26 is cooked, the individual would desire to lift the shish-kebob by means of skewer 12 and rotate it on the skewer axis 180 degrees so that that portion of the food which is distant from the grate, would now be resting on the grate to insure uniform cooking and heat throughout the food. The problem is that the food on the skewer, tends to seek its lowest center of gravity and once having been heated on one side, tends to spin or rotate on skewer 12 making it difficult for the individual to facilely lift the skewer and rotate it 180 degrees so that the uncooked side of the food is now in proximity to grate 26. Additionally, it will be recognized that for rotating the skewer, the individual's fingers or a hot pad must come in contact with the skewer 12 and depending upon the heat of the fire, the skewer itself may have become hot or charred which could impart a singe or burn to the fingers of the chef or to the hot pad.

There therefore has been a need for a facile way in which to pick up the shish-kebob and replace it on the grill so that the side distant from the grill in the initial cooking is now proximate to the grill or grate for uniform cooking and simultaneously avoid burning or singeing one's skin.

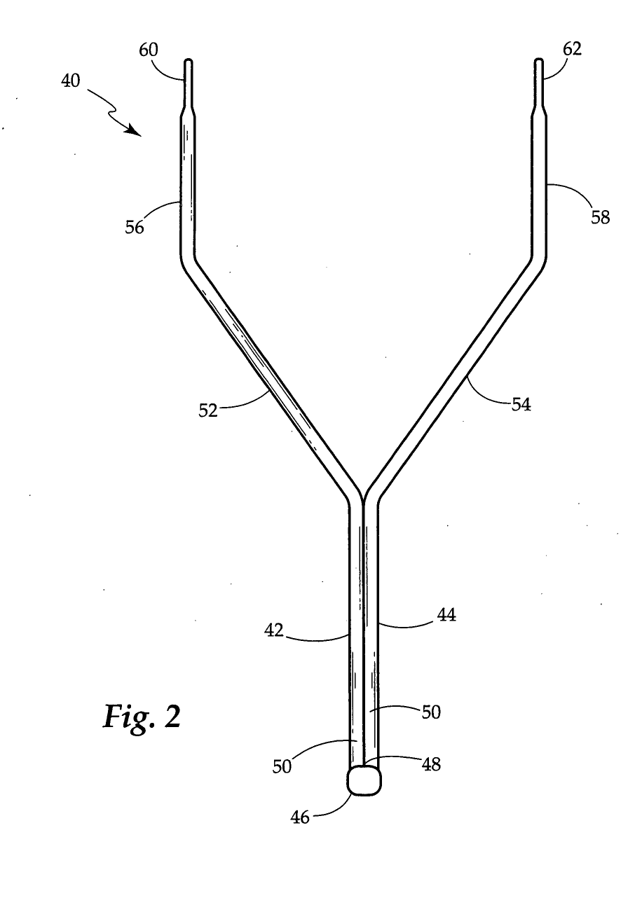

FIG. 2 is a top planar view of the shish-kebob tong 40 of the present invention. Shish-kebob tong 40 comprises two arms 42 and 44, each having three segments or legs. Arms 42 and 44 are joined at a pivot point 46 which may include a lockable, spring-loaded hinge 48. The initial segments 50 of arms 42 and 44 are parallel when in a closed, locked position, and form the handles of the shish-kebob tongs. Arms 42 and 44 become divergent at the end of segments 50, divergent segments 52 and 54 terminate in third segments 56 and 58 which are essentially in a parallel, spaced apart orientation in the locked, closed position illustrated in FIG. 2. Segments 56 and 58 terminate in shish-kebob engaging ends 60 and 62. Shish-kebob engaging ends 60 and 62 resemble the ends of conventional tongs in that they are somewhat scalloped in their perimeter to aid in engaging food. Shish-kebob engaging ends 60 and 62 are designed to engage the skewer 12 of the shish-kebob and to engage by frictional compression the food items positioned on the ends of the shish-kebob.

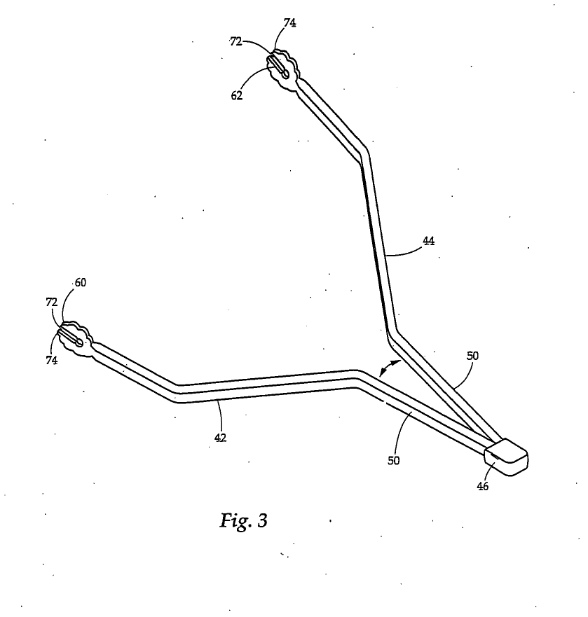

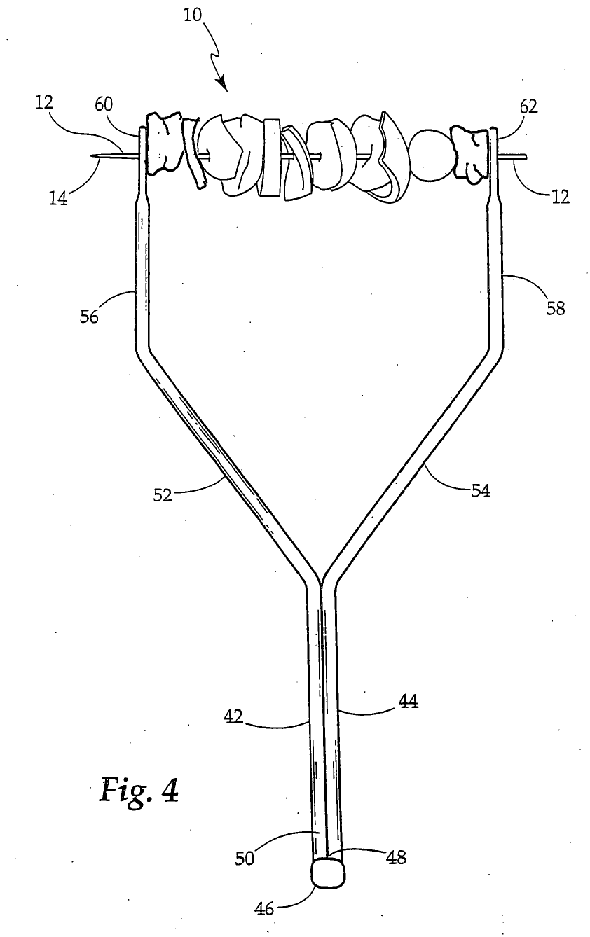

FIG. 3 is a perspective view of the shish-kebob tong 40 in an open configuration, and FIG. 4 is a top view of shish-kebob tong 40 engaged with a shish-kebob 10. Most shish-kebob skewers have a length of from between 9 inches and 14 inches, although longer shish-kebob skewers are available. Therefore, the opening distance of engaging ends 60 and 62 of the shish-kebob tongs 40 must be sufficient to accommodate a skewer between 9 and 14 inches so the distance between the shish-kebob engaging ends of the shish-kebob tong when open should be capable of spanning this distance and engaging the end of the skewer 12 and 15 which are not covered with food items. The engagement of the ends of the skewer 10 is accomplished by a pair of parallel slots 72 formed in the periphery of the shish-kebob engaging ends 60 and 62. In this improved embodiment, the slot 72 is formed in the tip 74 of each shish-kebob engaging end 60 and 62 and allows for the skewer to be slidably engaged in the slot as described hereafter.

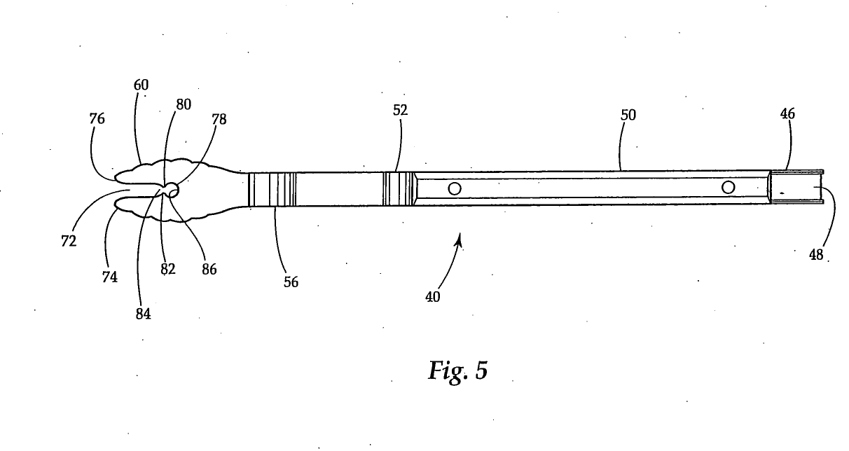

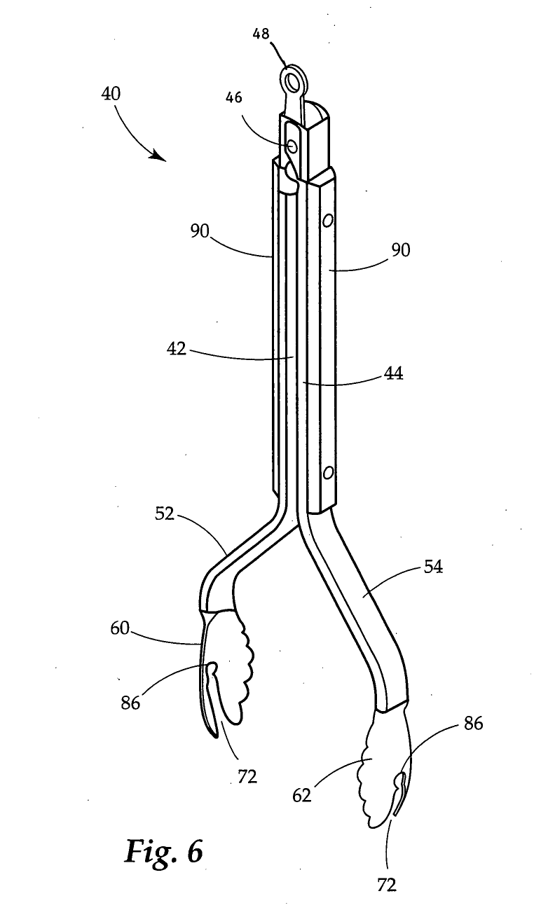

FIG. 5 is a side view of the shish-kebob tong of the present invention illustrating the improvement in the engaging ends 60 and 62, and FIG. 6 is a perspective view of tongs 40 illustrating the improvement. The skewer slidably engages through a slot in each of the shish-kebob engaging ends of the shish-kebob tongs, and the shish-kebob engaging ends would have contacted the outermost pieces of food located on the skewer and slightly compress the food items as illustrated in FIG. 4. This allows the chef or user to facilely lift the skewer and food items and rotate the shish-kebob tongs 180 degrees in his hand and in so doing flipping the shish-kebob 180 degrees longitudinally to replace it on the grilling grate 26 in order to uniformly cook the opposing side of the shish-kebob. Once so positioned, the release of pressure on the handle segment 50 of the shish-kebob tong 40 allows arms 42 and 44 to extend away from each other so that the slots can be slidably disengaged from the shish-kebob.

The shish-kebob engaging ends 60 and 62 have a slot 72 formed in the tip 74 of the shish-kebob engaging end having an open end 76, allowing the skewer to slidably pass into the slot, the shish-kebob handle 50 then being slightly compressed so that engaging ends 60 and 62 then contact and slightly compressing the food items on the skewer for the repositioning of the skewer or lifting of the skewer from the grill.

The slot 72 may be further formed with a pair of opposing notches 80 and 82 which defines a narrow gap 84 which communicates with a generally circular aperture 86 at slot 76's interior terminal end 78 in which a skewer 10 of circular cross section is positioned and engaged when manipulated by the tongs. Gap 84 and circular aperture 86 are dimensioned to cooperate to allow the circumference of a skewer to pass through gap 84 and be secured when the shish-kebob are being flipped or carried or transferred from a grill. Shish-kebob engaging end 62 would have a similar, complimentary configuration. FIGS. 5 and 6 also illustrate the option of insulation members or strips 90 secured to handle segments 50 of tong arms 42 and 44.

The skewers illustrated in the figures accompanying this application show the skewer primarily as a pointed skewer having a circular cross section, since these are the most common types of skewers utilized in shish-kebob barbecue. The improved slot with notch for encapsulating a portion of the circumference of the skewer has particular application to skewers of a circular cross section. However, the shish-kebob tongs of the present invention can also serve to firmly grasp, rotate, and transport skewers having a different cross section configuration, such as flat, or double configured skewers. The slots formed in the shish-kabob engaging ends of the shish-kebob tongs of the present invention are of a sufficient depth to safely and accurately handle such skewers of additional cross section in the same fashion and with the same purpose as the skewers having circular cross section as described primarily in this application.

Therefore, while the present invention has been disclosed with respect to the preferred embodiments thereof, it will be recognized by those of ordinary skill in the art that various changes and modifications can be made without departing from the spirit and scope of the invention. It is therefore manifestly intended that the invention be limited only by the claims and the equivalence thereof.

I claim:

1. Tongs for manipulating shish-kebob on a barbeque grill, shish-kebobs comprising an elongate skewer having food portions selectively removably positioned thereon, said shish-kebob positioned on a barbeque grill in a generally horizontal orientation, the tongs comprising:
in a closed orientation, two opposing arms in articulating relationship joined together at a first pivot end, said opposing arms extending from said first pivot end initially in parallel abutting relationship before angularly diverging and then converging to a parallel spaced apart relationship, each terminating in a second end, said second ends in parallel spaced apart relationship with each other, said second ends formed with shish-kebob engaging members for engagement with exposed extended ends of said horizontally oriented skewers of said shish-kebob, said members engaging said skewer and frictionally engaging outer food portions positioned on said skewer and preventing their rotation as said skewer and said shish-kebob are flipped from side to side for even cooking and for removal from the grill, said shish-kebob engaging members having a slot formed in each of said shish-kebob engaging member, said slot extending horizontally inwardly from a peripheral tip of said shish-kebob engaging member for the slidable engagement of exposed skewer ends of said skewer of said shish-kebob, each slot in alignment with each other.

2. The tongs for manipulating shish-kebob on a barbeque grill in accordance with claim 1 wherein said slot is in parallel relationship to said arms of said tongs.

3. The tongs for manipulating shish-kebob on a barbeque grill in accordance with claim 1 wherein said slot formed in said shish-kebob engaging member have an open end for passage of an end of said skewer and a closed end, said closed end having a narrowing passage defining a notch partially enwrapping said circumference of said skewer for securing said skewer.

4. The tongs for manipulating shish-kebob on a barbeque grill in accordance with claim 1 wherein said two opposing arms in articulate relationship joined together at a first pivot end are formed with a locking means at said first pivot end of said two opposing arms to selectively maintain said tongs in a locked closed position with said arms extending from said first pivot end in parallel abutting relationship or in an open orientation with said arms extending from said first pivot end in divergent non-parallel relationship for engaging said shish-kebobs and said skewer of differing lengths.

5. The tongs for manipulating shish-kebob on a barbeque grill in accordance with claim 1 wherein said second ends in parallel relationship of said two opposing arms are in spaced apart parallel relationship sufficient to engage said exposed extended skewer ends of said shish-kebob and said outer food portions positioned on said skewer, said opposing arms of sufficient length to extend over a barbeque grill.

6. Tongs for manipulating shish-kebob on a barbeque grill, said shish-kebob engaging members having a slot formed in each of said shish-kebob engaging members, said slot extending inwardly from said peripheral edge of said shish-kebob engaging members for the slidable engagement of exposed skewer ends of said skewer on said shish-kebob, each slot in alignment with each other, and each slot having a terminal interior end formed with a notch for further engagement of said skewer of a shish kabob wherein said skewer is circular in cross section.

7. The tongs for manipulating shish-kebob on a barbeque grill in accordance with claim 6 wherein said slot is perpendicular to said arms of said tongs.

8. The tongs for manipulating shish-kebob on a barbeque grill in accordance with claim 6 wherein said slot is in angular relationship with respect to said arms of said tongs.

9. The tongs for manipulating shish-kebob on a barbeque grill in accordance with claim 6 wherein said two opposing arms in articulate relationship joined together at a first end are formed with a locking means at said first end of said two opposing arms to selectively maintain said tongs in a locked closed position with said arms extending from said pivot end in parallel abutting relationship or in an open orientation with said arms extending from said pivot end in divergent non-parallel relationship for engaging said shish-kebobs and said skewer of differing lengths.

10. The tongs for manipulating shish-kebob on a barbeque grill in accordance with claim 6 wherein said second ends in parallel relationship of said two opposing arms are in spaced apart parallel relationship sufficient to engage said exposed extended skewer ends of said shish-kebob and said outer food portions positioned on said skewer, said opposing arms of sufficient length to extend over barbeque grill.
